(19) United States
(12) Patent Application Publication
(10) Pub. No.: US 2003/0042450 A1
(43) Pub. Date: Mar. 6, 2003

(54) Force-balanced gas control valve

(76) Inventor: Raul A. Bircann, Penfield, NY (US)

Correspondence Address: Delphi Technologies, Inc., P.O. Box 5052, Mail Code 480414420, Troy, MI, 48007, US

(21) Appl. No.: 09/944,556

(22) Filed: Aug. 31, 2001

(51) Int. Cl. F02M 25/07

(52) U.S. Cl. 251/129.07; 123/568.26

(57) ABSTRACT

A force-balanced gas control valve assembly having an integral cylindrical actuator housing and tubular valve body. A mounting flange attached to the housing has a central aperture through which the valve body projects. An annular valve seat is provided in the valve body. A pintle shaft within the valve body has a valve head matable with the valve seat, a force-balancing piston, an interstem separating the valve head from the piston, and an armature extending into a solenoid actuator subassembly disposed within the actuator housing. The pintle is formed of a ferromagnetic material such as a magnetic stainless steel. In a flow chamber within the valve body, pressure is exerted equally on both the piston, in a direction tending to open the valve, and the valve head, in a direction tending to close the valve. Thus the valve is force-balanced, and the solenoid need operate against only the frictional forces within the valve itself. Preferably, the valve assembly includes a low-friction composite guiding sleeve between the armature and the polepieces of the solenoid.

### TECHNICAL FIELD

The present invention relates to valves for controlling the flow of gas; more particularly, to valves for controlling the mixing of two gases; and most particularly, to a simplified and miniaturized force-balanced poppet valve for controlling the recirculation of exhaust gas into the intake manifold of an internal combustion engine.

### BACKGROUND OF THE INVENTION

It is well known to controllably recirculate a portion of the stream of exhaust gas emanating from an internal combustion engine into the intake manifold thereof. Such controlled recirculation can improve fuel economy and reduce formation of smog-forming oxides by lowering combustion temperature within the engine. Exhaust gas recirculation (EGR) systems typically include a solenoid-actuated poppet-type valve disposed directly between a port in the exhaust manifold and a port in the intake manifold. The solenoid and valve pintle are axially actuated to vary the flow of exhaust gas into the intake manifold in response to output signals from an engine control module which is programmed to respond to the status of a number of engine operating parameters.

Current gas control valves are complex and encompass numbers of components with corresponding interfaces therebetween. These components can require fabrication processes which are exotic, cumbersome, and expensive, and the stack-up tolerances can be difficult and expensive to accommodate. The components can require use of threaded fasteners for assembly which can be unreliable and can pose problems in attaining and maintaining consistent clamp loads. Current valves generally are constructed to fit a specific vehicle application, and therefore lack universality which would permit application of a single valve design across a wide range of vehicle requirements. Current valves are required to overcome a large pressure difference in to either opening or closing and therefore require a solenoid actuator which is large, powerful, expensive, and cumbersome relative to the size of the valve head to be actuated.

It is a principal object of the present invention to provide an improved and simplified gas control valve having relatively few components.

It is a further object of the invention to provide such a valve wherein force from pressure difference cross the valve is neutralized by the construction arrangement of valve components, permitting miniaturization of the solenoid actuator.

### SUMMARY OF THE INVENTION

Briefly described, an improved force-balanced gas control valve in accordance with the invention has an integral cylindrical actuator housing and tubular valve body preferably formed in one piece by deep drawing of metal, for example, stainless steel. A mounting flange is fusibly attached to the housing as by furnace welding and has a central aperture through which the valve body portion projects. An annular valve seat is provided by insertion or forming at the anterior end of the valve body. A valve pintle has four distinct portions: a valve head portion sealingly matable with the valve seat; a force-balancing piston portion sealingly disposed within the valve body between the head and the actuator; an interstem portion separating the valve head from the piston; and an armature portion for extending axially into the polepieces of a solenoid actuator disposed within the actuator housing. Because a portion of the pintle serves as the solenoid armature, the entire pintle is formed of a magnetic material, for example, a ferromagnetic stainless steel. The actuator is retained within the housing as by crimping of the outer or free edge of the actuator housing. The interstem portion extends through a gas flow chamber within the valve body. Pressure is exerted equally on the piston, in a direction tending to open the valve, and on the valve head, in a direction tending to close the valve. Thus the valve is force-balanced, and the solenoid need operate against only the frictional forces within the valve itself. Frictional forces are preferably reduced by including a low-friction metal/polymer composite guiding sleeve between the armature and the primary pole piece.

### BRIEF DESCRIPTION OF THE DRAWINGS

These and other features and advantages of the invention will be more fully understood and appreciated from the following description of certain exemplary embodiments of the invention taken together with the accompanying drawings, in which:

FIG. 1 is a cross-sectional elevational view of a prior art solenoid-actuated gas flow control valve;

FIG. 2 is a cross-sectional elevational view of a first embodiment of a solenoid-actuated gas flow control valve in accordance with the invention; and

FIG. 3 is a view like that shown in FIG. 2 showing a second embodiment.

### DESCRIPTION OF THE PREFERRED EMBODIMENTS

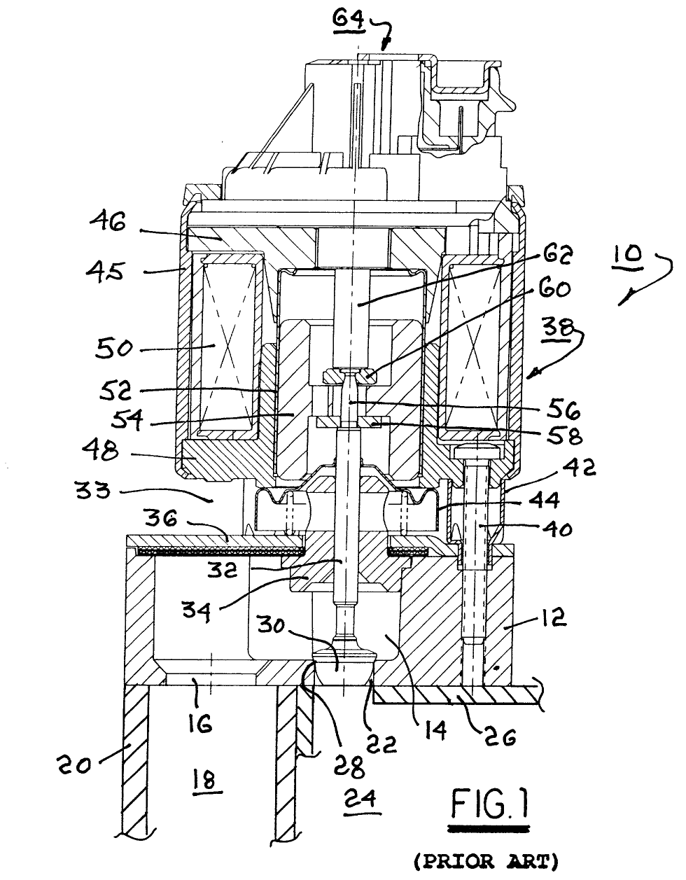

Referring to FIG. 1, a prior art solenoid-actuated gas control valve assembly 10 includes a valve body 12 mounted on a first engine manifold 20 and a second engine manifold 26. Valve body 12 encloses a first chamber 14 communicating via an outlet port 16 with a second chamber 18 within first engine manifold 20, typically an exhaust gas manifold. A port 22 into chamber 14 communicates with a third chamber 24 within second engine manifold 26, typically an intake manifold. Port 22 includes a valve seat 28 for sealably mating with a valve head 30 coaxially disposed on a pintle shaft 32. Shaft 32 is supported for reciprocating motion by a journal bearing 34 disposed in a wall 36 of valve body 12. A splash shield 44 prevents external contaminants from reaching pintle shaft 32 through the opening 33 between the actuator and the valve body. Valve body 12 is boltable to first and second manifolds 20,26 via bolt holes and bolts (not shown).

A solenoid-actuator subassembly 38 is attached via one or more bolts 40 to valve body 12 through one or more standoff spacers 42. Subassembly 38 includes a housing 45, primary polepiece 46, secondary polepiece 48, and coil 50. A cylindrical non-ferromagnetic guide sleeve 52 is captured within polepieces 46,48 for guiding armature 54 in reciprocating motion therein. Armature 54 has an axial bore for receiving end 56 of pintle shaft 32 which is captured on armature 54 between an annular keeper 58 disposed on a step in shaft 32 and retainer 60 which is mechanically retained by shaft 32, all as shown in FIG. 1. Shaft 32 abuts an axial indicator rod 62 which is slidable within position sensor subassembly 64 to indicate the axial position of valve head 30 with respect to valve seat 28.

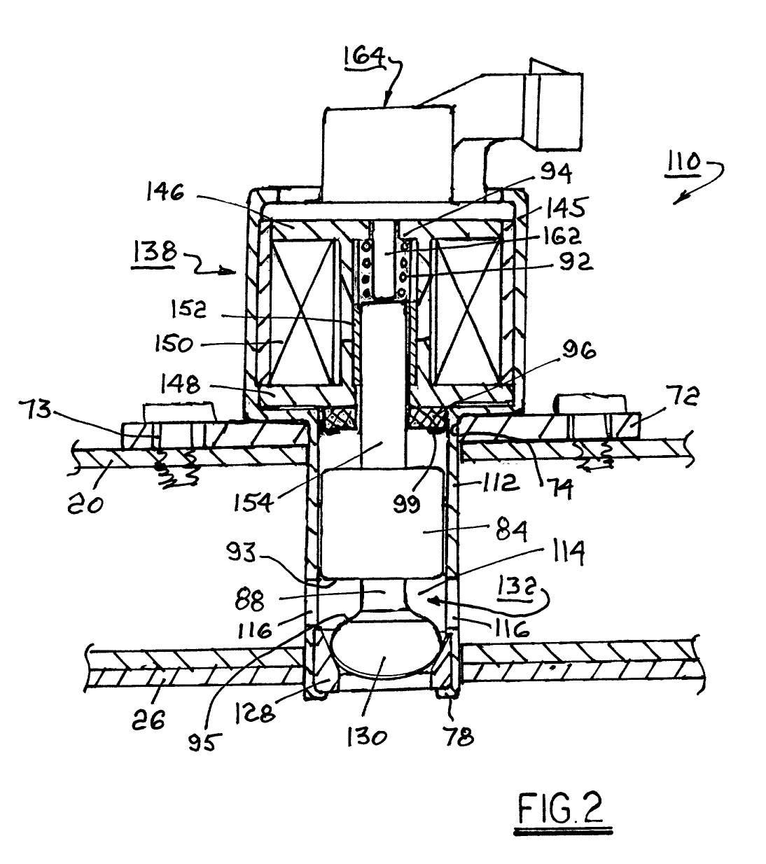

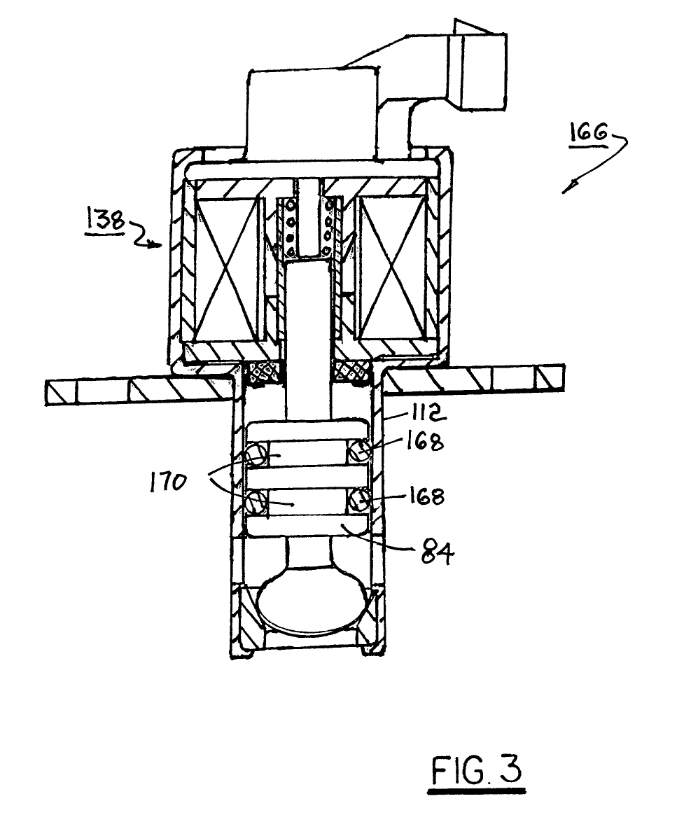

Referring to FIG. 2, an improved force-balanced gas control valve assembly 110 in accordance with the invention has an integral cylindrical actuator housing 145 and an elongate tubular valve body 112 preferably formed in one piece, preferably by deep drawing of metal, for example, stainless steel. (In FIGS. 2 and 3, components analogous to those shown in FIG. 1 are indicated by the same number plus 100.) A mounting flange 72 is connected, preferably fusibly, to housing 145 as by, for example, furnace welding, and has a central aperture 74 through which valve body 112 projects. Flange 72 has one or more bores 73 for bolting the assembly to a substrate such as manifolds 20, 26. A valve seat is provided by insertion of an annular seat element 128 or by forming a seat element as by inwardly rolling of the anterior end 78 of the valve body. Preferably, a separate seat element is provided as shown in FIG. 2, allowing for any of various seat configurations to be selected for use with a single size and shape of valve body.

A valve pintle shaft 132 has four distinct portions: a valve head portion 130 sealingly and variably matable with valve seat 128 to regulate the flow of gas through the valve; a force-balancing piston portion 84 sealingly disposed within valve body 112 between valve head 130 and actuator subassembly 138; an interstem portion 88 separating valve head 130 from piston 84; and an armature portion 154 for extending axially into actuator subassembly 138. Because portion 154 of the pintle serves as the solenoid armature, the entire pintle 132 is formed of a ferromagnetic material, for example, a magnetic stainless steel. Interstem portion 88 extends through a first chamber 114 within the valve body. Chamber 114 communicates with manifold 20 via ports 116 in valve body 112.

Actuator subassembly 138 includes a primary polepiece 146, a secondary polepiece 148, and a coil 150, all retained within housing 145 as by crimping of the outer or free edge of the housing. A position sensor subassembly 164 is also provided for sensing the axial position of pintle shaft 132.

Pintle shaft 132 is guided with respect to valve seat 128 by the close fit of piston 84 within tubular valve body 112. In addition, if desired a low-clearance, low-friction sleeve 152 is provided within the polepieces to center and guide armature 154, obviating the need for a separate guide bearing such as prior art journal bearing 34. Preferred materials for sleeve 152 are metal/polymer composites sold under the trade name “DU”, by Garlock Bearings, Inc., Thorofare, N.J., USA; and “Permaglide”, by INA Waelzlager Schaeffler oHG, Herzogenaurach, Germany. Sleeve 152 is conveniently formed by cylindrically compressing a section of composite sheet stock having a width slightly less than the inner circumference of the polepieces, inserting the compressed section into the polepieces, and releasing the section. The sleeve is self-retained in position as a cylindrical spring similar to a roll pin. Sleeve 152 further improves valve performance by reducing the air gap between the armature and the polepieces and assists in centering the armature in the magnetic field. Further, it permits horizontal orientation of the valve assembly, an impractical working orientation of the prior art valve because of wear and centering problems, thus enhancing flexibility of use.

Preferably, a compression spring 92 is included within the actuator subassembly surrounding indicator rod 162 and disposed between armature 154 and flange 94 on primary polepiece 146. Spring 92 cooperates with an internal spring (not shown) in position sensor 164 to urge the valve toward a closed position when the solenoid is de-energized.

Preferably, a woven filament mesh element 96 is provided within chamber 98 between piston 84 and secondary polepiece 148 and retained in sliding contact against pintle shaft 132 by bracket 99. Element 96 serves a triple function of acting as a resilient stop for travel of piston 84, filtering any air which passes by piston 84 from chamber 114, and continuously cleaning the surface of armature 154 during axial actuation thereof.

In operation of the valve assembly, pressure within chamber 114, defined by the length of interstem portion 88, is exerted equally on face 93 of piston 84, in a direction tending to open the valve, and on surface 95 of valve head 130, in a direction tending to close the valve. Thus the valve is force-balanced, and the opening solenoid and closing spring need operate against only the frictional forces within the valve assembly itself. Thus only a relatively small solenoid is required to perform the actuation requiring a much larger prior art solenoid for the prior art non-force-balanced valve 10. Frictional forces may be reduced by the inclusion of low-friction guiding sleeve 152 between armature 154 and pole pieces 146,148.

Advantages of an improved gas control valve in accordance with the invention are numerous.

First, the number and complexity of parts is reduced. Bearing 34, bolt 40, splash shield 44, keeper 58, and nut 60 are eliminated. Armature 154 is integral with the pintle shaft instead of separate. Housing 145 and valve body 112 are formed as a single unit requiring no joining means, unlike prior art housing 45 and valve body 12 which require joining by bolt 40 and standoff 42.

Second, because the valve body and pintle shaft are formed of stainless steel, no special anti-corrosion coatings are required.

Third, because the armature and pintle shaft are formed as a unit, alignment variations between them are eliminated. Further, the shaft is guided and aligned by the close-fitting metal/polymer composite sleeve in the solenoid subassembly, rather than by a separate bearing in the valve body, further reducing the number of parts and sources of alignment variability.

Fourth, because of equal areas on the piston face and the projected rear face of the valve head, all pneumatic forces in chamber 114 are automatically balanced and therefore are self-cancelling, permitting substantial reduction in size of actuator subassembly 138 over prior art subassembly 38, resulting in minimal power consumption, smaller size, and lower overall cost of manufacture.

Referring to FIG. 3, a second embodiment 166 is similar to first embodiment 110 with addition of one or more sealing rings 168 disposed in one or more annular grooves 170 formed in the outer wall of piston 84. Such rings can enhance the sliding seal between the piston and the wall of the valve body. Preferably, the sealing rings have a diagonal split similar to a conventional engine piston compression ring such that the ring is spring-biased outwards against the valve body at all times. Preferably, the rings are formed of copper because of its inherent lubricity, desirable stiffness matrix, and coefficient of thermal expansion, which attributes combine to offer good sealability with minimal hysteresis under all operating conditions.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A force-balanced gas control valve, comprising:
a) a tubular valve body;
b) a poppet valve seat disposed in said valve body;
c) a solenoid-actuator subassembly having primary and secondary polepieces and an electric coil, and having a housing attached to said valve body; and
d) a pintle shaft including a valve head for mating with said valve seat and having a first axial face, a piston having a second axial face opposed to said first axial face and being disposed within said tubular body, an interstem separating said first and second axial faces, and an armature extending axially into said subassembly.

2. A valve in accordance with claim 1 wherein said valve body and said housing are formed as a single unit.

3. A valve in accordance with claim 2 wherein said unit is formed of stainless steel.

4. A valve in accordance with claim 1 wherein the projected area of said second axial face of said piston substantially equals the projected area of said first axial face of said valve head such that opening and closing forces exerted by gas within said valve body on said first and second axial faces, respectively, are substantially equal and opposite.

5. A valve in accordance with claim 1 wherein said pintle shaft is formed of stainless steel having ferromagnetic properties.

6. A valve in accordance with claim 1 further comprising a guiding sleeve disposed between said armature and said polepieces, said sleeve being formed of a low-friction composite material.

7. A valve in accordance with claim 1 wherein said piston is provided with at least one annular groove on an outer surface thereof, and further comprising an annular compression ring disposed in said groove.

8. A valve in accordance with claim 1 further comprising a filament screen disposed around said pintle shaft between said piston and said subassembly.

9. A valve in accordance with claim I further comprising a mounting flange attached to said housing.
